(19) United States
(12) Patent Application Publication
(10) Pub. No.: US 2010/0190122 A1
(43) Pub. Date: Jul. 29, 2010

(54) CANDLE PROVIDED WITH A FOIL, AND METHOD AND APPARATUS FOR MANUFACTURING A CANDLE

(76) Inventor: Hendrikus Antonius van Dijk, Nijmegen (NL)

Correspondence Address: DORSEY & WHITNEY, LLP;INTELLECTUAL PROPERTY DEPARTMENT, 370 SEVENTEENTH STREET, SUITE 4700, DENVER, CO, 80202-5647, US

(21) Appl. No.: 12/669,268

(22) PCT Filed: Jul. 18, 2008
(86) PCT No.: PCT/NL2008/050494

§ 371 Date: Mar. 17, 2010

(30) Foreign Application Priority Data
Jul. 19, 2007 (NL) 1034166

(51) Int. Cl. F23D 3/16; B23P 11/00; B32B 3/24

(52) U.S. Cl. 431/289; 29/428; 29/700; 428/137

(57) ABSTRACT

The invention relates to a candle provided with a body to be consumed comprising a fuel, such as paraffin, and a wick, wherein a part o the wick which is to burn is situated in use at an upper surface of the body to be consumed. The candle is furthermore provided with a foil which abut at least partly against the upper surface of the body to be consumed, wherein the foil is designed to be exclusively borne by the body to be consumed. The invention further relates to a method and apparatus for manufacturing such a candle.

The invention relates to a candle provided with a body to be consumed comprising a fuel, such as paraffin, and a wick, wherein a part of the wick which is to burn is situated in use at an upper surface of the body to be consumed.

Such candles are known per se. Examples of such candles are for instance pillar candles, block candles, floating candles and tealight candles. In contrast to dinner candles and dip candles, which at the part of the wick that is to burn are provided with a pointed end, the known pillar candles, block candles, floating candles and tealight candles, etc., possess an upper surface that may be of, for instance, substantially plane, slightly convex or slightly concave design.

It is known that the upper surface of the known candles upon burning of the candle can melt in part or in whole, in order to supply the flame of the candle at the wick with fuel, for instance in the form of molten paraffin. In particular in the known tealight candles, also referred to as tealights, which are provided with a, typically aluminum, holder for holding therein the body of paraffin to be consumed, the entire upper surface of the candle may have melted in use.

This fact has led to the situation that the upper surface of the known candle in practice has an appearance with little appeal to the imagination. Mostly the upper surface is of substantially planar, slightly convex or slightly concave design, while possibly the fuel, for instance the paraffin, is provided in a color, which results in a monotonous upper surface. Also known are attempts whereby the upper surface has been provided with a relief pattern, for instance an image, so as to provide a less monotonous upper surface. It will be clear, however, that after melting of at least a part of the upper surface the original upper surface will be deformed, as a result of which the original appearance, for instance the image, will be deformed.

It is an object of the invention to obviate at least one of the above-mentioned disadvantages.

To that end, according to the invention, a candle is made available which is provided with a body to be consumed comprising a fuel, such as paraffin, and a wick, wherein a part of the wick which is to burn is situated in use at an upper surface of the body to be consumed, which is characterized in that the candle is furthermore provided with a foil which abuts at least in part against the upper surface of the body to be consumed, wherein the foil is designed to be exclusively borne by the body to be consumed.

Thus the foil, since it abuts at least partly against the upper surface, can initially, that is, before the candle is burnt, give the upper surface of the candle a desired appearance, for instance by the presence of a printing on the foil. Since the foil is designed to be exclusively borne by the body to be consumed, the foil, upon consumption of the body to be consumed, will follow a falling level of the upper surface of the body to be consumed, without being hampered in this following movement. The foil, for instance in its entirety, will follow the upper surface of the candle, for instance when it comes down as a result of the fuel being burnt. This is because the foil is exclusively borne by the body to be consumed, shrinking in use, and not by other, possibly non-shrinking or differently shrinking, parts of the candle, such as the wick. To this end, for instance, the foil may be situated at some distance from the wick. Consequently, the foil will not, at least hardly so, deform in use. Thus, the original appearance of the upper surface of before the consumption of the body to be consumed remains intact to a large extent during use of the candle.

Preferably, the foil abuts exclusively against the body to be consumed. Thus it is effected in a simple manner that the foil is exclusively borne by the body to be consumed.

Preferably, the foil is exclusively connected with the body to be consumed. Thus it is effected in a simple manner that the foil is exclusively borne by the body to be consumed.

Preferably, the foil is connected with the body to be consumed through a glue. Thus, for instance in unused condition, the foil remains well connected with the body to be consumed.

Preferably, the foil is designed as a self-adhesive foil. This provides the advantage of allowing the foil to be placed on the upper surface of the body to be consumed in a very simple manner, whether by hand or by machine.

Preferably, a shape and dimension of the foil corresponds substantially to a shape and dimension of the upper surface of the body to be consumed.

Preferably, the foil is designed to float on the fuel, when this is in liquid form. Thus the foil can also give the upper surface the desired appearance in use, for instance with the body molten, and even after (partial) consumption, for instance after resolidification of the body.

It is noted that from FR 2 687 408 a candle is known where an upper surface of the paraffin body to be consumed and an upper edge of a holder in which the body to be consumed is accommodated are covered with a layer of lacquer which can float on the molten paraffin, in order to control molten paraffin flowing out of the holder when inclined. It will be clear that the layer of lacquer in the candle of FR 2 687 408 deforms strongly upon consumption of the candle, since the layer of lacquer is also connected with the upper edge of the holder, so that the original appearance of the layer of lacquer is lost in use. Moreover, in the candle of FR 2 687 804, a dimension of an opening in the layer of lacquer through which the wick extends increases according as the candle is burnt up further. This allows ingredients included in the paraffin, such as anti-odor or anti-insect constituents, to evaporate to an increasing extent through the enlarging opening at undesired times when the candle is not being burnt.

It will be clear that the candle according to the invention at the same time provides a solution to this last problem, since the foil is exclusively borne by the body to be consumed and hence will not, at least hardly so, deform, so that any opening in the foil through which the wick extends will not, at least hardly so, deform, and during the consumption of the candle will hardly if at all increase in dimension. This may further contribute to a prolongation of the burning time of the candle, since evaporation of the fuel can be controlled by the foil.

Preferably, the foil is nonflammable. This affords the advantage of providing a safe candle, with the appearance of the upper surface not being affected by the burning of the foil. Nonflammable is herein understood to mean that the foil in use is substantially not destroyed by the heat of the flame of the candle. Preferably, it holds that the foil is at least nonflammable in the immediate vicinity of the wick, where the temperature of the foil, as a result of the heat of the flame, would otherwise exceed an ignition temperature of the foil.

Preferably, the foil is printable and/or has been printed. This affords the advantage that the upper surface of the candle may be provided with a desired appearance, such as a desired picture.

Preferably, the foil is substantially non-deformable in the plane in which the foil extends. The foil may for instance be inelastic. This provides the advantage that the original appearance of the foil, for instance the picture provided thereon, is not deformed in the plane of the foil, so that the original appearance is preserved. The foil may possibly be so flexible as to allow of deformation transversely to the plane in which it extends.

In an embodiment, the foil consists of a layer of ink, lacquer and/or toner. Thus the ink, lacquer and/or toner can be applied to the body and be dried and/or hardened to form the foil. In this way, the foil can be provided on the body in a simple manner.

In an embodiment, the foil comprises a plastic foil or metal foil. Such a foil can be manufactured cheaply and with it the upper surface can be provided with desired effects such as metallic luster, glitter, color, etc. The metal foil, in particular aluminum foil, provides the advantage of having good properties regarding nonflammability and processing ease, in particular in automated placement of the foil on the body to be consumed.

In an embodiment, the foil comprises a porous foil, as from paper or fabric, which is soaked in a, preferably nonflammable, substance such as a, preferably nonflammable, glue and/or a, preferably nonflammable, lacquer. Thus, in a simple manner, the preferably nonflammable foil is provided, while the porous foil can be formed from an inexpensive starting material. In an exemplary embodiment, the porous foil may for instance have been obtained from a, possibly preprinted, napkin, which provides as an advantage that such napkins are commercially available with a great diversity of printings, which for instance are well in line with occasions for which the candle with the foil on the upper surface is made available, such as festivities, such as Christmas, Easter, birthdays, etc.

If the foil has a good heat conductivity, as for instance in the case of the metal foil, the foil may also contribute to the melting of the fuel, so that the fuel can be supplied to the wick in an efficient manner.

Preferably, the wick extends through an opening in the foil. Thus, an area around the wick may be provided with the foil, which may be beneficial to a fine appearance of the upper surface. Here too, the foil may be situated at a distance from the wick. It is for instance possible that a dimension, such as a diameter, of the opening is greater than a dimension, such as a diameter, of a cross section of the wick in a plane in which the foil extends. The diameter of the opening is preferably more than 0.1 and less than 10 mm, more preferably approximately 4 mm, greater than the diameter of the cross section of the wick. In this way, the foil can move freely relative to the wick very well, for instance in a downward direction when the candle is burning. Preferably, the diameter of the opening is 440 mm, for instance approximately 8 mm. It has been found that such a diameter permits a good transport of molten fuel via the wick through the opening.

In practice, the fuel, for instance the molten paraffin, may after some time flow through the opening onto the upper surface of the foil and there form a thin layer of the fuel. In case of the more flammable foil, this provides for an efficient protection from burning of the foil. Since only a thin layer of the fuel is thereby formed on the foil, the foil can still be deemed to substantially float on the fuel.

In an embodiment, the upper surface is substantially circular, as for instance in cylindrical pillar candles, floating candles and tealight candles.

It is possible that the foil covers substantially the whole upper surface around the wick, for instance the whole upper surface around the wick. Thus, less evaporation of the fuel occurs, which augments the life of the candle.

The invention further relates to a foil designed to be attached to an upper surface of a candle provided with a body to be consumed comprising a fuel, such as paraffin, and a wick, wherein the foil is provided with a hole for passing the wick therethrough. Preferably, the foil is provided with a self-adhesive layer for therewith attaching the foil to an upper surface of the body to be consumed.

The invention further relates to an assembly of a candle according to the invention and a holder for holding therein the body to be consumed of the candle, as is the case for instance with tealights. Preferably, the foil is then free of connection with the holder.

The invention further relates to a method for manufacturing a candle.

According to the invention, there is provided a method for manufacturing a candle, comprising providing a body to be consumed comprising a fuel, such as paraffin, and a wick, applying a foil to an upper surface of the body to be consumed, such that the foil abuts at least partly against the upper surface of the body to be consumed, and that the foil is exclusively borne by the body to be consumed, and applying the wick on, to or in the body to be consumed, such that a part of the wick which is to burn is situated in use at the upper surface of the body to be consumed.

Thus a method is provided for manufacturing a candle according to the invention. It will be clear that it is possible that the foil is then designed to float on the fuel, when this is in liquid form.

Preferably, applying the foil to the upper surface of the body to be consumed comprises laying the foil exclusively against the body to be consumed. Thus it is effected in a simple manner that the foil is exclusively borne by the body to be consumed.

Preferably, applying the foil to the upper surface of the body to be consumed comprises connecting the foil exclusively with the body to be consumed. Thus it is effected in a simple manner that the foil is exclusively borne by the body to be consumed.

Preferably, the foil is connected with the body to be consumed through a glue. Preferably, the foil is designed as a self-adhesive foil. The foil can then comprise a plastic foil and/or, preferably, a metal foil, such as aluminum foil.

In an embodiment, applying the foil comprises applying a layer of ink, lacquer and/or toner on the body, and drying and/or hardening the ink, lacquer and/or toner.

In an embodiment, the method further comprises providing the foil as a finished foil before the foil is applied to the body. Thus the foil can be provided as a semimanufactured product and be combined with the body to be consumed and the wick to form the candle according to the invention. Here, a dimension and/or shape of the foil can be adapted to a dimension and/or shape of the candle, before the foil is applied to the body. Accordingly, the foil can for instance be cut or punched before the foil is applied to the body.

Preferably, the dimension and/or shape of the foil corresponds substantially to the dimension and/or shape of the upper surface of the consumable body. Thus, substantially the whole upper surface may be covered with the foil.

Preferably, the method comprises providing an opening in the foil for passing therethrough at least a part of the wick.

Preferably, the method comprises treating the foil with a substance for rendering the foil nonflammable, at least that part of the foil which in use is situated in the immediate vicinity of the wick.

In an embodiment, applying the foil furthermore comprises applying a, preferably nonflammable, adhesion means to the body to be consumed and/or to the foil. Thus the foil can be simply adhered to the body to be consumed through the adhesion means. Here, the foil can be a porous foil, as of paper or fabric, and applying the foil can furthermore comprise contacting the porous foil and the adhesion means when the adhesion means is liquid, for inclusion of at least a part of the adhesion means into the porous foil. Thus the porous foil can be rendered nonflammable.

The invention furthermore relates to an apparatus for manufacturing a candle provided with a body to be consumed comprising a fuel, such as paraffin, a wick, wherein a part of the wick which is to burn is situated in use at an upper surface of the body to be consumed, and a foil which abuts at least partly against the upper surface of the body to be consumed, comprising a foil placing unit for applying the foil to the upper surface of the body to be consumed. Thus the candle provided with the foil can be manufactured in an automated manner.

Preferably, the foil placing unit is designed for applying the self-adhesive foil. Thus, in a simple manner, the self-adhesive foil can be applied in an automated manner to the upper surface of the body to be consumed of the candle.

In an embodiment, the foil placing unit comprises a placing head which is designed for taking up the foil at a first location and applying the foil to the upper surface of the body to be consumed at a second location. Preferably, the foil placing unit is provided with positioning means for aligning the candle without the foil relative to the placing head. Thus an accurate positioning of the candle without the foil relative to the placing head is achieved, so that the foil can be applied to the body to be consumed while accurately positioned.

Preferably, the placing head comprises aligning means for aligning the foil relative to the placing head. Thus the foil can be accurately positioned relative to the placing head, so that the foil can be applied to the body to be consumed while accurately positioned.

In an embodiment, the apparatus is furthermore provided with an erecting unit for placing the wick substantially vertically upright. Thus it can be effected in an automated manner that the wick is upright before the foil is applied, so that the wick can be passed through an opening in the foil.

The invention will presently, by way of non-limiting example, be elucidated in more detail with reference to the drawing. In the drawing:

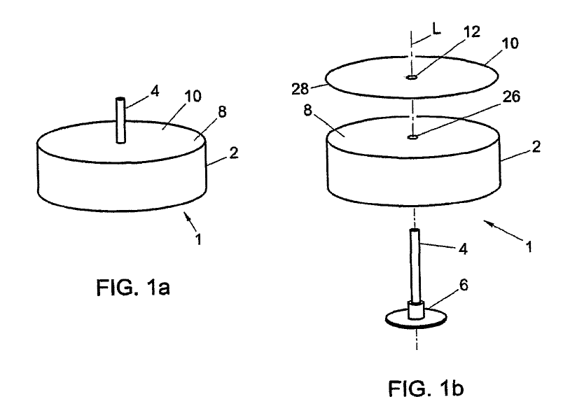

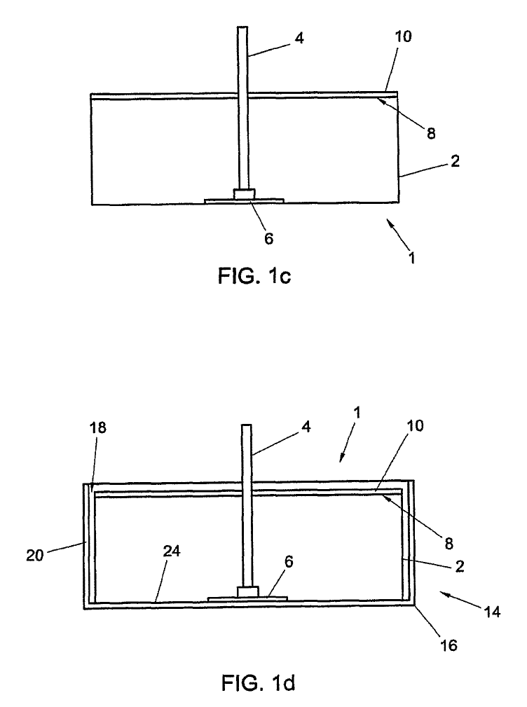

FIG. 1a is a schematic representation of a first embodiment of a candle according to the invention;

FIG. 1b is an exploded view of the candle shown in FIG. 1a;

FIG. 1c is a cross section of the candle shown in FIG. 1a;

FIG. 1d is a cross section of an assembly of the candle shown in FIGS. 1a-1c and a holder;

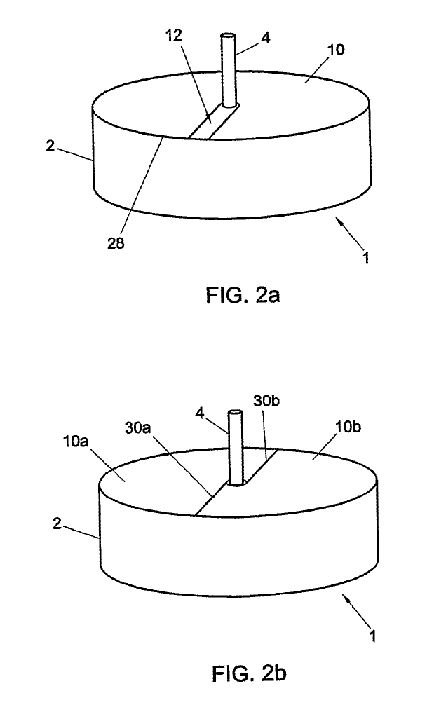

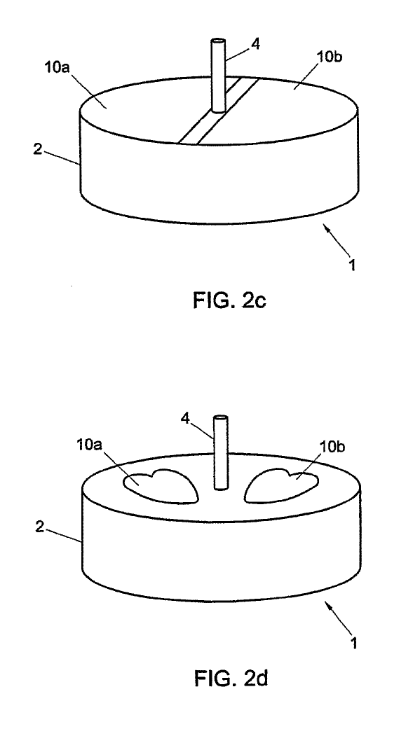

FIGS. 2a-2f are schematic representations of second through seventh embodiments of a candle according to the invention; and

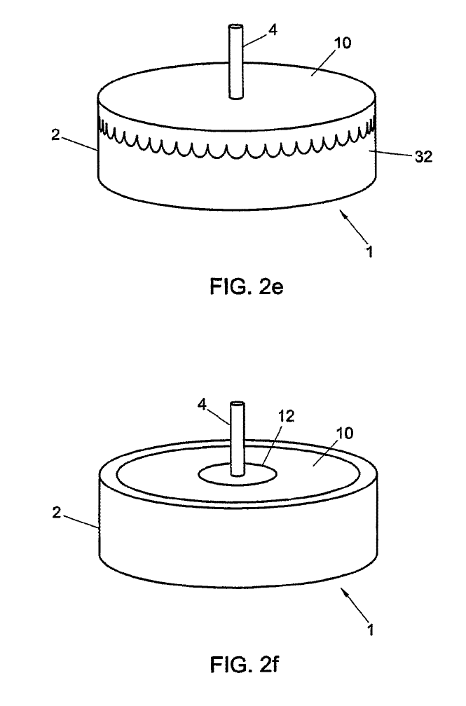

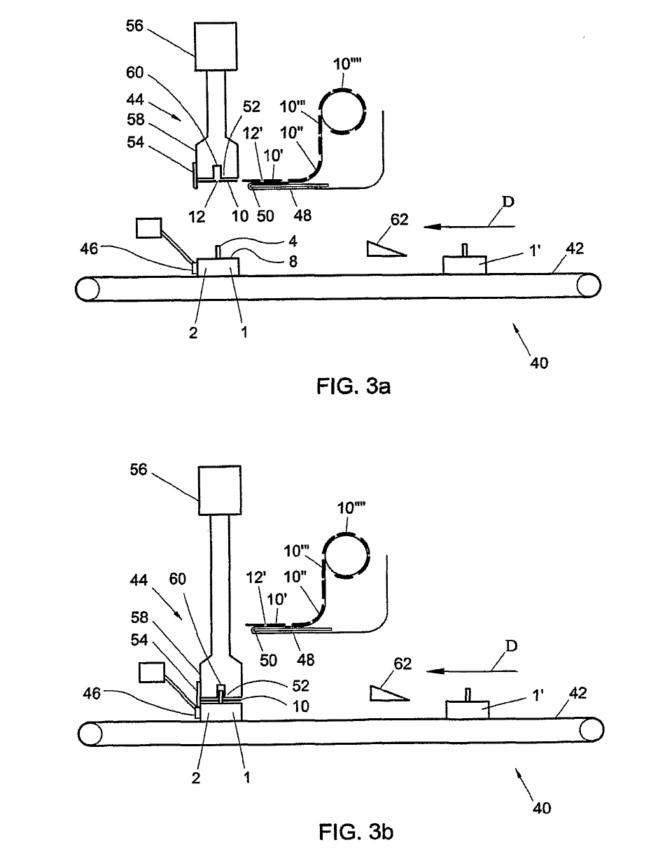

FIGS. 3a and 3b are schematic representations of an embodiment of an apparatus for manufacturing a candle according to the invention.

FIG. 1a shows a schematic representation of a first embodiment of a candle 1 according to the invention. FIG. 1b shows an exploded view of the candle 1 shown in FIG. 1a. FIG. 1c shows a cross section of the candle 1 shown in FIG. 1a. The candle 1 comprises a body 2 to be consumed. The body to be consumed comprises a fuel for the candle, which fuel is consumed upon burning of the candle 1. In this example, the body 2 to be consumed comprises paraffin In this example, the body 2 to be consumed is manufactured from paraffin. However, the body to be consumed may also comprise a different fuel, such as for instance beeswax or other type of wax, or a gel.

The candle 1 furthermore comprises a wick 4. In this example the wick 4 is designed as a taper, for instance of cotton. In FIG. 1b it can be seen that in this example the wick 4 is further provided with a base 6 for holding the wick upright. The base 6 may for instance be manufactured from a metal, such as aluminum. In FIG. 1a it can be seen that a part of the wick 4 which is to burn is situated in use at an upper surface 8 of the body 2. In this example, the wick extends externally of the body 2, from the upper surface 8. In this example the wick 4 is situated substantially on the centerline L of the candle 1. In this example, the upper surface 8 is substantially circular.

In the example of FIGS. 1a and 1b, the candle 1 is furthermore provided with a foil 10. The foil 10 is placed on the upper surface 8 of the body 2, such that the foil 10 is exclusively borne by the body 2 to be consumed. The foil 10 then abuts against the upper surface 8. In the example of FIGS. 1a-1c, the wick 4 extends through an opening 12 in the foil 10. In this example, the foil 10 covers the whole upper surface 8 around the wick 4.

In this example, the body 2 to be consumed comprises paraffin. In use, the wick 4 will be heated, for instance with a match, for causing the paraffin to melt. Near the wick 4, a part of the body 2 will melt and be sucked up by the wick by capillary action. Thus the fuel is supplied to the wick to feed a flame there.

In this example, the foil 10 is nonflammable, that is, the foil is resistant to the heat of the flame of the candle, and is substantially not destroyed thereby. It will be clear that in general it holds that, preferably, the foil is at least nonflammable in the immediate vicinity of the wick, where the temperature of the foil, as a result of the heat of the flame, would otherwise exceed an ignition temperature of the foil. To that end, the foil may for instance be wholly or partly manufactured from a plastic nonflammable for this purpose or a metal, such as aluminum. The foil may then for instance be provided with a self-adhesive layer for therewith connecting the foil 10 with the upper surface 8 of the body 2 to be consumed. The foil may therefore be designed as a sticker. The glue of the sticker is for instance a rubber glue and/or silicone glue, since this glue adheres well to solid paraffin and does not mix with molten paraffin, which ensures a good flame quality.

In this example, however, the foil 10 is designed as the porous foil manufactured from paper, which has been soaked, in this example saturated, in a nonflammable substance such as a nonflammable glue and/or a nonflammable lacquer, such as for instance water glass. It will be clear that it is also possible that only the part of the porous foil which, in use, is situated in the immediate vicinity of the wick has been soaked in the nonflammable substance. Alternatively, for the foil, a baking paper can be used which is relatively well resistant to the heat of the flame of the candle.

In this example, the foil 10 is designed to float on the fuel, when this is in liquid form. Thus the foil will be borne by the upper surface 8 both when it is solid and when it is liquid.

The foil 10 may for instance be printed with a picture to give the upper surface 8 of the candle 1a fine appearance. In this case, the picture will be visible when the body is solid and when the body is liquid. Moreover, when the foil is nonflammable, the picture will remain visible, possibly undeformed, even until the candle has been used up.

In this example, the foil 10 is substantially non-deformable in the plane in which the foil extends. The foil may be deformable transversely to the plane in which the foil extends. The foil may thus be, for instance, flexible and inelastic. Thus the foil 10, in use, can abut against the upper surface 8 and to a certain extent follow a contour of the upper surface. A dimension of the opening 12 in the foil 10, however, will for instance remain substantially constant, so that the foil, in this example, continues to cover the whole upper surface. Thus an appearance that the upper surface had prior to a first use of the candle 1, for instance a picture on the foil, can continue to be perceived, substantially undeformed, during use of the candle 1.

FIG. 1d shows a cross section of an assembly 14 of the candle 1 shown in FIGS. 1a-1c and a holder 16. In this example, the holder 16 is designed as a thin-walled tray, for instance of metal, such as aluminum. Thus the assembly 14 can for instance be designed as a tealight. In general, it holds for the tealight that the candle 1 has been loosely inserted into the holder 16. Accordingly, there is no fixed mechanical connection between the candle 1 and the holder 16. To allow the candle 1 to be loosely inserted into the holder 16, there will be some clearance 18 in radial direction between an outer circumference of the body 2 of the candle 1 and an inner side of a circumferential wall 20 of the holder 16.

In the example of FIG. 1d, it holds that the foil 10 is free of connection with the holder 16. The foil 10 is thus not fixedly connected with the holder 16. The foil 10 is thus not borne by the holder 16. In this example, the foil is not connected with the wick 4 either. Thus the foil is not borne by the wick 4. Therefore it holds in this example that the foil is exclusively borne by the body 2 to be consumed of the candle 1. This provides the advantage that if the candle 1 is used, whereby a height of the body to be consumed, for instance a level of the fuel in the holder 16, decreases, the foil 10, floating on the upper surface 8 of the body to be consumed which shrinks in the height direction, can follow the upper surface and thereby move towards a lower side of the body, for instance towards a bottom 24 of the holder 16. As a result, the foil 10, in use of the candle 1, for instance in the holder 16, will be situated at all times at the upper surface 8 of the body 2 to be consumed as it shrinks. As indicated hereinabove with respect to FIGS. 1a-1c, the foil can then abut on the upper surface while being substantially free of deformation, so that for instance any picture on the foil can be perceived, undeformed, during substantially the whole life of the candle 1, possibly in the holder 16.

The candle 1 described so far can be manufactured as follows.

The body 2 to be consumed, for instance comprising paraffin, is provided. In this example, the body 2 to be consumed has already been provided with a bore 26 for passing the wick 4 therethrough. Next, the upper surface 8 of the body 2 is provided with a layer of a, preferably nonflammable, adhesion means, such as a layer of glue and/or a layer of lacquer. After this, the foil 10 is placed on the layer of adhesion means. It will be clear that alternatively, or additionally, it is also possible to provide an underside of the foil 10 with the adhesion means, it being possible, as already set out hereinbefore, that the foil is designed as a sticker.

Preferably, the foil 10 has already been prepared for the candle 1. To this end, a dimension and/or shape of the foil 10 may already have been adapted to a dimension and/or shape of the candle 1, before the foil 10 is applied to the body 2. It is for instance possible that the dimension and shape of the foil correspond substantially to the dimension and shape of the upper surface 8 of the candle. Thus the foil 10 has been prepared to cover substantially the whole upper surface 8. Preferably, the foil 10 has then already been provided with the opening 12 for passing at least a part of the wick 4 therethrough before the foil is placed on the body 2. After the foil 10 has been applied to the body, the wick 4 may be arranged in the bore 26 and the opening 12. It will be clear that it is also possible to provide the bore 26 and/or the opening 12 after the foil 10 has been placed on the upper surface 8. It is also possible to apply the foil 10 after the wick 4 has been arranged on the body 2 to be consumed.

If desired, the thus obtained candle 1 can be placed in the holder 16 for forming the assembly 14. As set out hereinabove, it provides advantages to arrange for the foil to be exclusively connected with the body.

In a particular variant, the foil 10 is a porous foil, for instance of paper or fabric. In that case, it is highly desirable that the adhesion means is the nonflammable adhesion means. If the porous foil 10 is placed on the layer of the adhesion means when the layer of the adhesion means is wet, the porous foil 10 can take up at least a part of the adhesion means. In this way, the porous foil gets soaked, for instance saturated, with the, preferably nonflammable, liquid adhesion means of the adhesion layer. Thus, for instance after hardening and/or drying of the layer of the adhesion means, the nonflammable foil is obtained. A particularly suitable porous foil can be obtained from, possibly preprinted, napkins, for instance by punching or cutting the foil which has been adapted to the shape and/or dimension of the upper surface, from the napkin. The preprinted napkins are commercially available with a great diversity of prints, which are for instance well in line with occasions for which the candle 1 with the foil 10 on the upper surface 8 is made available, for instance festivities, such as Christmas, Easter, birthdays, etc.

It is also possible that the foil is designed for changing an appearance thereof during the burning of the candle. The foil may for instance comprise a dye which changes color under the influence of temperature. The foil will then have a different appearance depending on whether the candle is burning or not. It is then also possible that the color(s) and the changed color(s) have been chosen such that a picture on the foil changes under the influence of the temperature, for instance in that particular parts of the picture change from a foreground color to a background color and vice versa. Such a change of the appearance may be reversible. Instead of being sensitive to the temperature of the flame, the changeable dye may for instance be sensitive to the light of the flame.

Changing of the appearance may also be achieved in that the foil comprises multiple lacquer layers, while at least the outer lacquer layer evaporates or disappears otherwise or becomes transparent, under the influence of the heat (and/or light) of the flame of the candle. Thus, for instance after the candle has burnt for some time, an image formed by the outer lacquer layer will have disappeared and an image of a further lacquer layer, present under the outer lacquer layer, will be visible. Such a change of the appearance can be irreversible. For instance by providing a multiplicity of such lacquer layers, moving images may be simulated on the foil.

FIGS. 2a-2f show schematic representations of second through seventh embodiments of a candle 1 according to the invention.

In FIG. 2a the opening 12 in the foil 10 is designed as a slot which extends from the wick 4 as far as a circumferential edge 28 of the foil. The slot provides the advantage that the foil can be simply positioned with respect to the wick if the wick is already present when placing the foil.

In FIG. 2b the foil is designed as an assembly of a first partial foil 10a and a second partial foil 10b. The partial foils 10a and 10b in this example abut against each other laterally, along seams 30a and 30b. Thus the partial foils 10a, 10b in this example cover substantially the whole upper surface 8, and the partial foils 10a, 10b can be simply placed if the wick is already present when placing the partial foils.

In FIG. 2c the foil is also designed as an assembly of a first partial foil 10a and a second partial foil lob. In this example, the partial foils 10,10b together do not cover the whole upper surface.

In FIG. 2d the foil is also designed as an assembly of a first partial foil 10a and a second partial foil 10b. In this example, the partial foils 10a, 10b together do not cover the whole upper surface. In this example the partial foils are provided with a figurative shape, here a heart shape. It will be clear that since in this example the partial foils 10a, 10b are situated at a relatively greater distance from the wick 4, it may be of lesser relevance for the partial foils 10a, 10b to be nonflammable. It will also be clear that the partial foils 10a, 10b can move relative to each other in the plane of the upper surface 8 if at least one partial foil is floating on the molten consumable body. In that case, the original appearance of the upper surface 8 of before the first use of the candle 1 may be lost.

In FIG. 2e the foil 10 extends over substantially the whole upper surface 8 of the body 2. The foil 10 in this example extends also, at least partly, over the cylinder surface 32 of the body. Thus a different appeal of the candle 1 can be created. It will be clear that also in the example of FIG. 2e the foil is exclusively borne by the body 2 to be consumed, even when the body 2 with the foil according to FIG. 2e is placed in the holder 16.

In FIG. 2f the foil 10 does not extend over the whole upper surface 8, but does extend around the wick 4.

FIGS. 3a and 3b show schematic representations of an embodiment of an apparatus 40 for manufacturing a candle 1 according to the invention. The apparatus 1 comprises conveying means 42, in this example designed as a moving belt. By means of the moving belt 42, candles 1, 1′ are conveyed in the direction of the arrow D.

The apparatus 40 comprises a foil placing unit 44 for placing the foil 10 on the upper surface 8 of the body 2 to be consumed of the candle 1. The foil placing unit 44 in this example comprises a placing head 58 for taking up the foil 10 before it has been placed on the body 2 to be consumed, and applying the foil to the body 2 to be consumed.

The foil placing unit 44 in this example furthermore comprises a stop 46. During conveyance of the candle 1, the stop 46 is at such a position that conveyance of the candle 1 is not hindered. In this example, the stop 46 is lifted, such that the candle 1 can pass under the stop. During placement of the foil 10 on the candle 1, the stop 46 is positioned such that the candle 1 is stopped. In the example, the moving belt 42 keeps moving continuously, so that the candle 1 slips over the belt while the foil is being placed. It will be clear that a further candle 1′ will simply move with the belt 42 during the placement of the foil 10 on the first-mentioned candle 1. The stop 46 in this example is moreover so designed that the candle is aligned with respect to the placing head 58. To that end, the stop can for instance have a V-shape, in top plan view, in which the candle's outer circumference, circular in this example, is captured. The stop 46 accordingly functions as positioning means for aligning the candle with respect to the placing head 58.

In this example, the foil 10 is designed as a sticker. A multiplicity of the self-adhesive foils 10, 10′, 10″, 10′″, 10″″ are placed in the apparatus 40 on a roll of carrier material 48. The foil is, at least partly, detached from the carrier material 48 by having the carrier material perform a bending movement around a delivery point 50. The foil at least partly detached from the carrier material 48 is then taken up by means of a suction mouth 52 of the placing head. The suction mouth 52 retains the foil 10 by means of reduced pressure. In this example, the suction mouth 52 is provided with a limiter 54. In a lowered position, as shown in FIG. 3a, the limiter 54 prevents the foil 10 from slipping through upon suction of the foil 10 by means of the suction mouth 52. In this example, the limiter has a convex inner surface facing the foil 10 for stopping and positioning the foil. Thus the foil 10 can be provided on the suction mouth 52 while accurately positioned, for instance centered. The limiter 54 accordingly functions as aligning means for aligning the foil with respect to the placing head 58.

The limiter 54 and/or the stop 46 allow candles to be provided with foil at a high rate, that is, with a high repeat frequency, without this leading to inaccuracy in the positioning of the foil 10 on the candle 1.

When the foil 10 has been provided on the suction mouth 52, displacement means 56 displace the placing head 58 in downward direction until the self-adhesive side of the foil 10 is adhered onto the upper surface 8 of the candle 1 (see FIG. 3b). The limiter 54 in this example is connected with the placing head 58 in a manner slidable in height direction. Thus the limiter 54 can slide if the limiter comes into contact with the candle 1 and/or the stop 46. Thus the candle 1 will not be damaged by the limiter 54.

In the example of FIGS. 3a and 3b, the suction mouth 52 is provided with a cavity 60 for receiving therein the wick 4 of the candle 1. Thus the foil 10 can be placed on the upper surface of the body 2 to be consumed, while the wick 4 has already been provided on the body to be consumed. Naturally, it is also possible first to provide the foil 10 and then to provide the wick 4 on the body 2 to be consumed.

It will be clear that the apparatus 40 is suitable for placing the, preferably self-adhesive, foil 10 on the upper surface of the body 2 to be consumed of the candle 1, while the candle may be provided with the holder 16, as desired.

If desired, the apparatus 40 may furthermore be provided with an erecting unit 62 for placing the wick 4 substantially vertically upright before the candle 1 is provided with the foil 10. In this example, the erecting unit comprises two wedges which are on opposite sides of the wick 4. If the wick does not stand upright, the wick will butt against an inclined surface of at least one of the wedges and be placed substantially upright. If desired, the candle 1′ may be rotated when it passes the wedges. To this end, there may be arranged, for instance, a lateral friction surface, along which the upstanding outer circumference of the candle 1′ scrapes to impart an axial rotation to the candle 1′. Rotation of the candle 1′ promotes the upright placement of the wick 4 and reduces the chance of a candle passing the erecting unit 62 without the wick 4 being placed upright. It will be clear that placing the wick 4 upright facilitates placing the foil 10 on the upper surface 8 of the candle 1.

In the example of FIGS. 3a and 3b, the apparatus 40 as such is represented. It is possible that the apparatus 40 is included in-line in a system for producing candles, as for instance tealights. The candle is therefore provided with the foil in-line. The system here may comprise further apparatuses, such as for instance an apparatus for forming the body to be consumed, an apparatus for placing the wick in the body to be consumed, an apparatus for placing a holder around the body to be consumed, an apparatus for providing the finished candles with an outer package, etc.

In general, an aluminum foil is favorable, inter alia in view of the extent of nonflammability. Preferably, such an aluminum foil 10 has a thickness of between approximately 20 and 120 mμ, more preferably approximately 50 mμ. If the aluminum foil 10 is designed as the self-adhesive foil, the foil 10 may for instance be placed on the carrier material, while the carrier material may for instance comprise paper, such as silicone paper or wax paper. The carrier material may for instance be 20-200 mμ thick, for instance 40 mμ.

The invention is not in any way limited to the examples described above. It is for instance possible that the holder 16 is made available in a color and/or pattern, for instance one which is in line with a color and/or pattern of the foil. The holder, for instance the thin-walled aluminum tray, may for instance be lacquered or anodized in color.

In the examples, the body to be consumed is represented as a substantially cylinder-shaped body having a substantially plane upper surface. It will be clear that also other shapes of the body are possible, such as, for instance, but not exclusively, a bar shape. It is also possible that the upper surface is slightly convex (as may for instance be the case with floating candles) or slightly concave. Other shapes of the upper surface are not excluded either.

In the example, the foil is connected with the upper surface through the layer of the adhesion means. It will be clear that it is also possible for the foil to lie loosely on the upper surface. The foil may then for instance remain in position laterally in that the wick 4 extends through the opening 12 as shown in FIGS. 1a and 1b.

In the examples the foil is provided as a separate component of the candle and placed as a whole, or in parts, on the upper surface. It is also possible, however, that the foil is provided on the upper surface by applying a layer of ink, lacquer and/or toner on the upper surface of the body to be consumed, and drying and/or hardening the ink, lacquer and/or toner, so that the dried and/or hardened ink, lacquer and/or toner forms the foil which is exclusively borne by the body to be consumed.

In the example of FIGS. 3a and 3b, the foil is placed on the body to be consumed in accordance with FIGS. 1a-1d. It will be clear that the apparatus 40 is also suitable to place the foil on the body to be consumed in accordance with FIGS. 2a-2f.

All such variants are understood to fall within the framework of the invention.

1. A candle provided with a body to be consumed comprising a fuel, such as paraffin, and a wick, wherein a part of the wick which is to burn is situated in use at an upper surface of the body to be consumed, wherein the candle is furthermore provided with a foil which abuts at least in part against the upper surface of the body to be consumed, wherein the foil is designed to be exclusively borne by the body to be consumed.

2. A candle according to claim 1, wherein the foil exclusively abuts against the body to be consumed.

3. A candle according to claim 1 or 2, wherein the foil is exclusively connected with the body to be consumed.

4. A candle according to claim 1, wherein the foil is connected with the body to be consumed through a glue.

5. A candle according to claim 1, wherein the foil is designed as a self-adhesive foil.

6. A candle according to claim 1, wherein a shape and dimension of the foil substantially correspond to a shape and dimension of the upper surface of the body to be consumed.

7. A candle according to claim 1, wherein the foil is designed to float on the fuel, when this is in liquid form.

8. A candle according to claim 1, wherein the foil is nonflammable.

9. A candle according to claim 1, wherein the foil is nonflammable at least in the immediate vicinity of the wick.

10. A candle according to claim 1, wherein the foil is printable.

11. A candle according to claim 1, wherein the foil is substantially non-deformable in the plane in which the foil extends.

12. A candle according to claim 1, wherein the foil consists of a layer of ink, lacquer and/or toner.

13. A candle according to claim 1, wherein the foil comprises a plastic foil or metal foil.

14. A candle according to claim 1, wherein the foil comprises a porous foil, as of paper or fabric, which has been soaked in a, preferably nonflammable, substance, such as a, preferably nonflammable, glue and/or a, preferably nonflammable, lacquer.

15. A candle according to claim 1, wherein the wick extends through an opening in the foil.

16. A candle according to claim 1, wherein the upper surface is substantially circular.

17. A candle according to claim 1, wherein the foil covers substantially the whole upper surface around the wick.

18. A foil designed to be attached to an upper surface of a candle provided with a body to be consumed comprising a fuel, such as paraffin, and a wick, wherein the foil is provided with a hole for passing the wick therethrough and with a self-adhesive layer for therewith attaching the foil to an upper surface of the body to be consumed.

19. A foil according to claim 18, wherein a shape and dimension of the foil substantially correspond to a shape and dimension of the upper surface of the body to be consumed.

20. An assembly of a candle according to claim 1, and a holder for holding therein the body to be consumed of the candle.

21. An assembly according to claim 20, wherein the foil is free of connection with the holder.

22. A method for manufacturing a candle, comprising
providing a body to be consumed comprising a fuel, such as paraffin, and a wick,
applying a foil to an upper surface of the body to be consumed, such that the foil abuts at least partly against the upper surface of the body to be consumed, and that the foil is exclusively borne by the body to be consumed, and
applying the wick on, to or in the body to be consumed, such that a part of the wick which is to burn is situated, in use, at the upper surface of the body to be consumed.

23. A method according to claim 22, wherein applying the foil to the upper surface of the body to be consumed comprises
laying the foil exclusively against the body to be consumed.

24. A method according to claim 22 or 23, wherein applying the foil to the upper surface of the body to be consumed comprises
connecting the foil exclusively with the body to be consumed.

25. A method according to claim 22, wherein the foil is connected with the body to be consumed through a glue.

26. A method according to claim 22, wherein the foil is designed as a self-adhesive foil.

27. A method according to claim 22, wherein the foil comprises a plastic foil and/or metal foil.

28. A method according to claim 22, wherein the foil is designed to float on the fuel, when this is in liquid form.

29. A method according to claim 22, wherein applying the foil comprises applying a layer of ink, lacquer and/or toner to the body to be consumed, and drying and/or hardening the ink, lacquer and/or toner.

30. A method according to claim 22, furthermore comprising providing the foil as a finished foil before the foil is applied to the body to be consumed.

31. A method according to claim 30, wherein a dimension and/or shape of the foil is adapted to a dimension and/or shape of the candle, before the foil is applied to the body to be consumed.

32. A method according to claim 31, wherein the dimension and/or shape of the foil substantially corresponds to the dimension and/or shape of the upper surface of the body to be consumed.

33. A method according to claim 22, comprising providing an opening in the foil for passing at least a part of the wick therethrough.

34. A method according to claim 22, wherein the foil, at least in the immediate vicinity of the wick, is nonflammable.

35. A method according to claim 22, furthermore comprising treating the foil with a substance for rendering the foil, at least that part of the foil which, in use, is in the immediate vicinity of the wick, nonflammable.

36. A method according to claim 22, wherein applying the foil furthermore comprises
applying a, preferably nonflammable, adhesion means on the body to be consumed and/or on the foil.

37. A method according to claim 36, wherein the foil is a porous foil, as of paper or fabric, and applying the foil furthermore comprises
contacting the porous foil and the adhesion means when the adhesion means is liquid, for taking up at least a part of the adhesion means into the porous foil.

38. A method for manufacturing an assembly according to claim 22, comprising manufacturing the candle according to claim 22, and placing the candle in the holder.

39. A method according to claim 38, wherein the foil is free of connection with the holder.

40. An apparatus for manufacturing a candle provided with a body to be consumed comprising a fuel, such as paraffin, a wick, wherein a part of the wick which is to burn is situated in use at an upper surface of the body to be consumed, and a foil which abuts at least partly against the upper surface of the body to be consumed, comprising
a foil placing unit for applying the foil to the upper surface of the body to be consumed.

41. An apparatus according to claim 40, wherein the foil placing unit is designed for applying the self-adhesive foil.

42. An apparatus according to claim 40 or 41, wherein the foil placing unit comprises a placing head which is designed for taking up the foil at a first location and applying the foil to the upper surface of the body to be consumed at a second location.

43. An apparatus according to claim 42, wherein the foil placing unit is provided with positioning means for aligning the candle without the foil with respect to the placing head.

44. An apparatus according to claim 42, wherein the placing head comprises a suction mouth for therewith taking up the foil.

45. An apparatus according to claim 42, wherein the placing head comprises aligning means for aligning the foil with respect to the placing head.

46. An apparatus according to claim 40, furthermore provided with an erecting unit for placing the wick substantially vertically upright.

47. An apparatus according to claim 40, furthermore provided with conveying means for supplying the candle without foil to the foil placing unit and/or discharging the candle with the foil from the foil placing unit.
